(19) United States
(12) Patent Application Publication
(10) Pub. No.: US 2018/0197132 A1
(43) Pub. Date: Jul. 12, 2018

(54) SYSTEMS AND METHODS FOR DETERMINING PRODUCT SHIPPING COSTS FOR PRODUCTS SOLD FROM AN ONLINE RETAILER

(71) Applicant: WAL-MART STORES, INC., Bentonville, AR (US)

(72) Inventors: Amritayan Nayak, Sunnyvale, CA (US); Rajiv Jain, Fremont, CA (US); Sarabjeet Singh, San Francisco, CA (US)

(73) Assignee: WAL-MART STORES, INC., Bentonville, AR (US)

(21) Appl. No.: 15/401,674

(22) Filed: Jan. 9, 2017

(51) Int. Cl. G06Q 10/08; G06Q 30/06; G06Q 30/00

(52) U.S. Cl. CPC G06Q 10/083; G06Q 30/01; G06Q 30/0633

(57) ABSTRACT

Systems and methods including one or more processing modules and one or more non-transitory storage modules storing computing instructions configured to run on the one or more processing modules and perform acts of determining a product shipping cost for a product and coordinating a display on the electronic device of the user of the product shipping cost of a carrier shipping cost that is less than the maximum shipping cost for the product. The maximum shipping cost for the product can be determined by determining carriers comprising a transit time for shipping the product that is less than or equal to a shipping time requirement of a service level agreement with the user, determining a baseline cost for shipping the product, retrieving a fixed threshold cost for the product, and combining the fixed threshold cost and the baseline cost to determine a maximum shipping cost for the product.

### TECHNICAL FIELD

This disclosure relates generally to determining product shipping costs for products sold from an online retailer.

### BACKGROUND

When shopping online, customers or other users can be presented with shipping information for an order. This shipping information is conventionally constrained by daily shipping cutoff times. Moreover, the shipping information is conventionally based on which carrier can ship the one or more products of the order for the least expensive price.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 5;

FIG. 2 illustrates a representative block diagram of an example of the elements included in the circuit boards inside a chassis of the computer system of FIG. 1;

FIG. 3 illustrates a representative block diagram of a system, according to an embodiment;

FIGS. 4A-B are flowcharts for a method, according to certain embodiments; and

FIG. 5 illustrates a representative block diagram of a portion of the system of FIG. 3, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processing modules and one or more non-transitory storage modules storing computing instructions configured to run on the one or more processing modules. The one or more storage modules can be configured to run on the one or more processing modules and perform an act of receiving an indication of user interest in a product from a user accessing a website of an online retailer on an electronic device of the user. The one or more storage modules can be further configured to run on the one or more processing modules and perform an act of determining a product shipping cost for the product using the one or more processing modules and a first set of rules. The act of determining the product shipping cost for the product using the one or more processing modules and the first set of rules can include an act of determining a shipping time requirement of a service level agreement with the user. The act of determining the product shipping cost for the product using the one or more processing modules and the first set of rules can include an act of determining a plurality of carriers comprising a transit time for shipping the product that is less than or equal to a shipping time requirement of a service level agreement with the user. The act of determining the product shipping cost for the product using the one or more processing modules and the first set of rules can include an act of determining a plurality of carrier shipping costs for the product, each carrier shipping cost of the plurality of carrier shipping cost being associated with a different carrier of the plurality of carriers. The act of determining the product shipping cost for the product using the one or more processing modules and the first set of rules can include an act of determining a baseline cost for shipping the product, the baseline cost comprising a lowest carrier shipping cost of the plurality of carrier shipping costs. The act of determining the product shipping cost for the product using the one or more processing modules and the first set of rules can include an act of retrieving a fixed threshold cost for the product. The act of determining the product shipping cost for the product using the one or more processing modules and the first set of rules can include an act of combining the fixed threshold cost and the baseline cost to determine a maximum shipping cost for the product. The act of determining the product shipping cost for the product using the one or more processing modules and the first set of rules can include an act of determining one or more carrier shipping costs of the plurality of carrier shipping costs that are less than the maximum shipping cost for the product. The one or more storage modules can be further configured to run on the one or more processing modules and perform an act of coordinating a display on the electronic device of the user of the product shipping cost of the one or more carrier shipping costs that are less than the maximum shipping cost for the product as determined using the first set of rules and the one or more processing modules.

Various embodiments include a method. The method can include receiving an indication of user interest in a product from a user accessing a website of an online retailer on an electronic device of the user. The method also can include determining a product shipping cost for the product using one or more processing modules and a first set of rules. Determining a product shipping cost for the product using one or more processing modules and a first set of rules can include determining a shipping time requirement of a service level agreement with the user. Determining a product shipping cost for the product using one or more processing modules and a first set of rules also can include determining a plurality of carriers comprising a transit time for shipping the product that is less than or equal to a shipping time requirement of a service level agreement with the user. Determining a product shipping cost for the product using one or more processing modules and a first set of rules can include determining a plurality of carrier shipping costs for the product, each carrier shipping cost of the plurality of carrier shipping cost being associated with a different carrier of the plurality of carriers. Determining a product shipping cost for the product using one or more processing modules and a first set of rules can include determining a baseline cost for shipping the product, the baseline cost comprising a lowest carrier shipping cost of the plurality of carrier shipping costs. Determining a product shipping cost for the product using one or more processing modules and a first set of rules can include retrieving a fixed threshold cost for the product. Determining a product shipping cost for the product using one or more processing modules and a first set of rules can include combining the fixed threshold cost and the baseline cost to determine a maximum shipping cost for the product. Determining a product shipping cost for the product using one or more processing modules and a first set of rules can include determining one or more carrier shipping costs of the plurality of carrier shipping costs that are less than the maximum shipping cost for the product. The method also can include coordinating a display on the electronic device of the user of the product shipping cost of the one or more carrier shipping costs that are less than the maximum shipping cost for the product as determined using the first set of rules and the one or more processing modules.

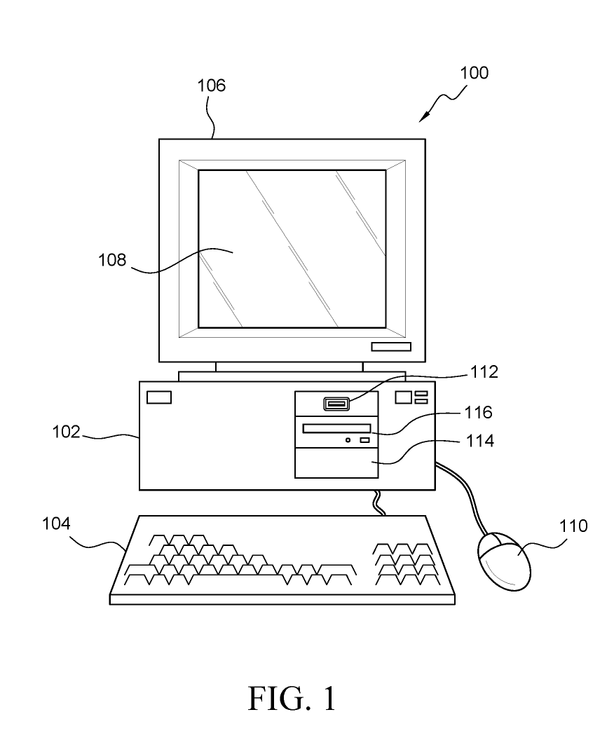

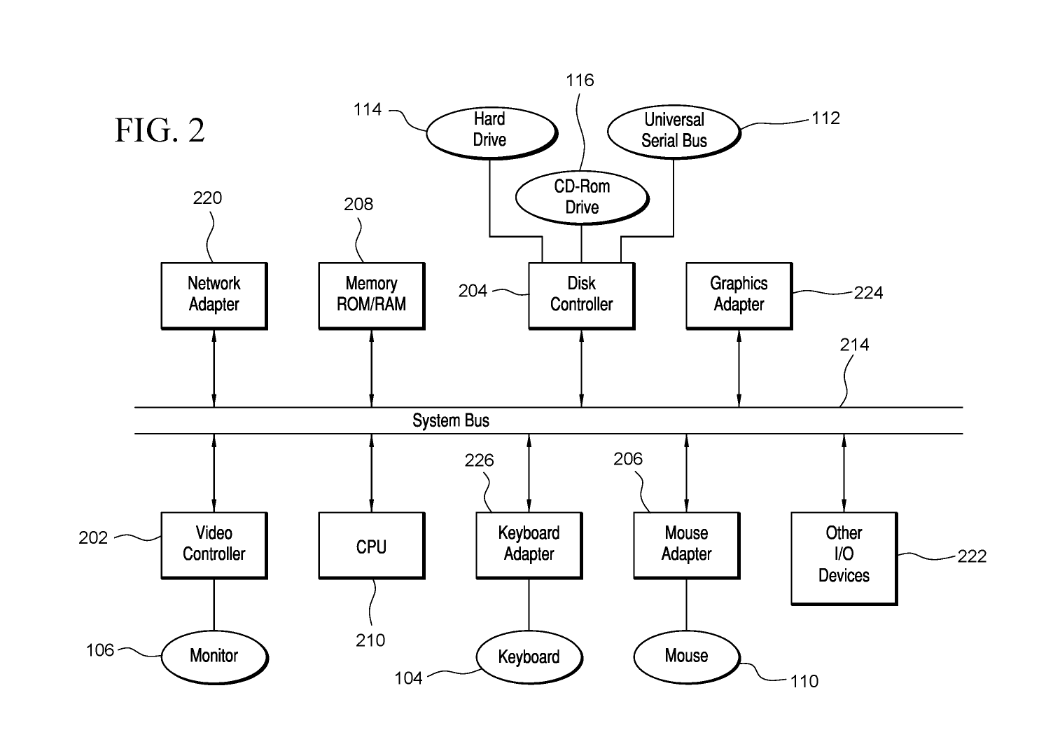

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1-2), hard drive 114 (FIGS. 1-2), a CD-ROM and/or DVD for use with CD-ROM and/or DVD drive 116 (FIGS. 1-2), a floppy disk for use with a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

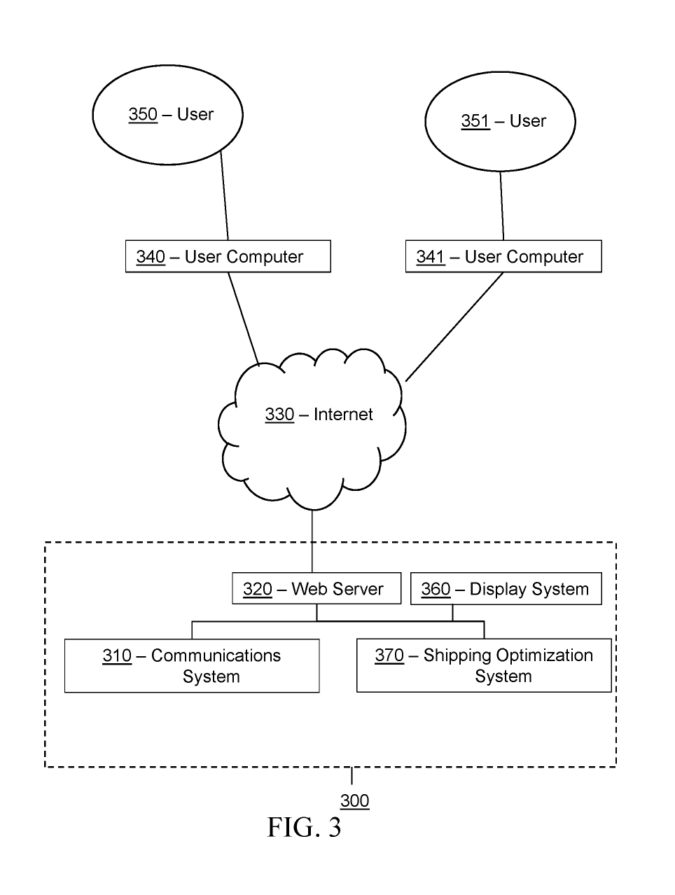

Turning ahead in the drawings, FIG. 3 illustrates a block diagram of a system 300 that can be employed for determining product shipping costs for products sold from an online retailer described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a communications system 310, a web server 320, a display system 360, and a shipping optimization system 370. Communications system 310, web server 320, display system 360, and/or shipping optimization system 370 can each be a computer system, such as computer system 100 (FIG. 1), as described above, and can each be a single computer, a single server, or a cluster or collection of computers or servers, or a cloud of computers or servers. In another embodiment, a single computer system can host each of two or more of communications system 310, web server 320, display system 360, and/or shipping optimization system 370, as described herein.

In many embodiments, system 300 also can comprise user computers 340, 341. In some embodiments, user computers 340, 341 can be a mobile device. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In some embodiments, web server 320 can be in data communication through Internet 330 with user computers (e.g., 340, 341). In certain embodiments, user computers 340-341 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, communications system 310, web server 320, display system 360, and/or shipping optimization system 370 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) communications system 310, web server 320, display system 360, and/or shipping optimization system 370 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of communications system 310, web server 320, display system 360, and/or shipping optimization system 370. In a similar manner, the processing module(s) and the memory storage module(s) can be local and/or remote to each other.

In many embodiments, communications system 310, web server 320, display system 360, and/or shipping optimization system 370 can be configured to communicate with one or more user computers 340 and 341. In some embodiments, user computers 340 and 341 also can be referred to as customer computers. In some embodiments, communications system 310, web server 320, display system 360, and/or shipping optimization system 370 can communicate or interface (e.g., interact) with one or more customer computers (such as user computers 340 and 341) through a network or internet 330. Internet 330 can be an intranet that is not open to the public. Accordingly, in many embodiments, communications system 310, web server 320, display system 360, and/or shipping optimization system 370 (and/or the software used by such systems) can refer to a back end of system 300 operated by an operator and/or administrator of system 300, and user computers 340 and 341 (and/or the software used by such systems) can refer to a front end of system 300 used by one or more users 350 and 351, respectively. In some embodiments, users 350 and 351 also can be referred to as customers, in which case, user computers 340 and 341 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, communications system 310, web server 320, display system 360, and/or shipping optimization system 370 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between communications system 310, web server 320, display system 360, and/or shipping optimization system 370, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

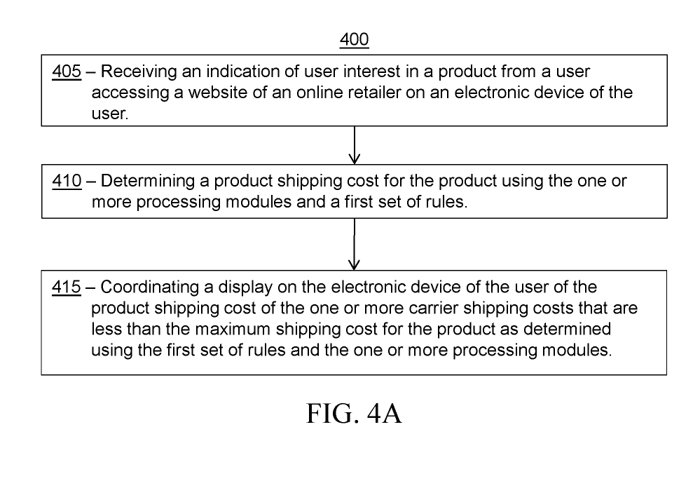

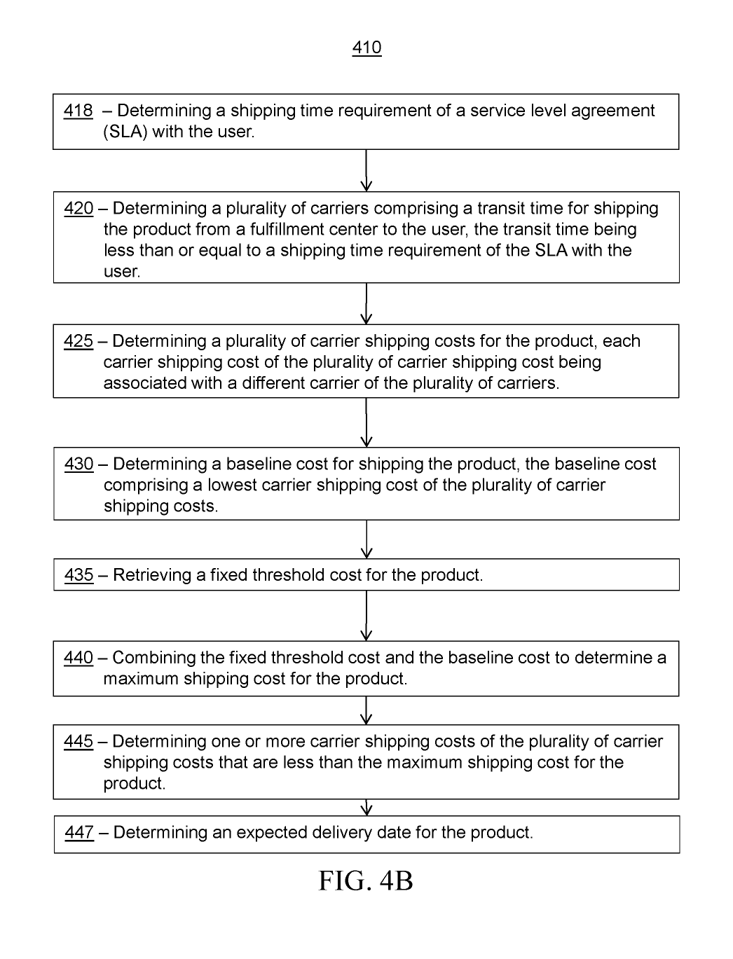

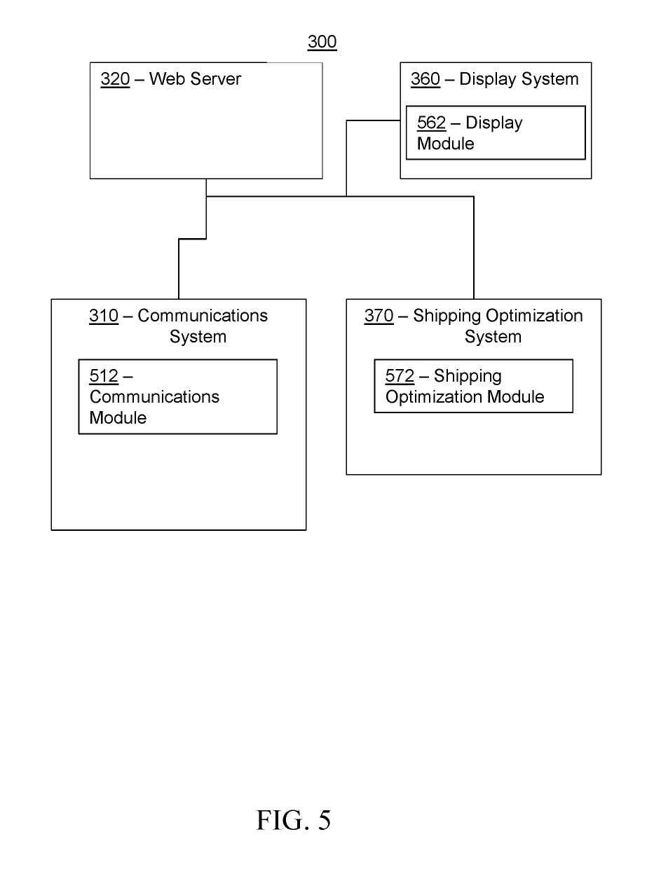

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules 512, 562 and/or 572 (FIG. 5). Such non-transitory memory storage modules can be part of a computer system such as communications system 310, web server 320, display system 360, and/or shipping optimization system 370 (FIGS. 3 & 5). The processing module(s) can be similar or identical to the processing module(s) described above with respect to computer system 100 (FIG. 1).

In some embodiments, method 400 can comprise an activity of selecting an optimal delivery option using one or more processing modules and a second set of rules. The second set of rules can comprise a consolidation algorithm that is a combinatorial heuristic algorithm used to select the most optimal delivery option the online retailer should use to fulfill an order. The consolidation algorithm can comprise several activities to make this selection. In some embodiments, each activity of the consolidation algorithm is exponential in complexity. The code to implement consolidation can use a branch and bound algorithm for each activity. This implementation ensures that the consolidation algorithm can run in essentially real time so that fulfillment can be quick and efficient.

In some embodiments, the activity of selecting the optimal delivery option using the second set of rules can comprise an activity of generating a plurality of combinations of distributors that can fulfill an order for the product. The distributors can comprise a warehouse for the online retailer, a third party fulfillment center, or a physical brick and mortar store for the online retailer. For example, if a customer orders a first product and a second product, the second set of rules looks for all distributors that have the first product and all the distributors that have the second product available to fulfill.

In some embodiments, the activity of selecting the optimal delivery option using the second set of rules can further comprise an activity of assigning a product quantity to each combination of the plurality of combinations of distributors to create different assignments for the plurality of combinations of distributors. For example, in the order above for the first product and the second product, the second set of rules can create the following options: Distributor LA (product1, 5, product2, 2); Distributor PA (product1, 3); Distributor NY (product1, 2, product2, 2), where product1 is the first product, product2 is the second product, LA is a first distributor location, PA is a second distributor location, NY is a third distributor location, and the number after product1 or product2 is a quantity of the first product or the second product at that particular distributor.

In some embodiments, the activity of selecting the optimal delivery option using the second set of rules can further comprise an activity of assigning a carrier of the plurality of carriers to one of the different assignments for the plurality of combinations of distributors. Returning to the example provided above, the assigned carriers can be: Distributor LA, FedEx; Distributor PA, UPS; Distributor NY, UPS.

In some embodiments, the activity of selecting the optimal delivery option using the second set of rules can further comprise an activity of creating a solution that can fulfill the entire order now. The solutions can comprise a combination of the distribution center, product quantity, and assigned carrier. In some embodiments, the activity of selecting the optimal delivery option using the second set of rules can further comprise an activity of selecting a least expensive solution for the order.

In some embodiments, method 400 can comprise an activity of determining an optimal fulfillment/delivery option that will meet a service level agreement (SLA) between the online retailer and the user using one or more processing modules and a third set of rules. The third set of rules can comprise a SLA sourcing algorithm that applies the consolidation algorithm of the second set of rules to each SLA group of products. The SLA group of products can comprise a specific SLA requirement, such as but not limited to two business days shipping. The SLA sourcing algorithm of the third set of rules can comprise multiple activities.

In some embodiments, activity of determining the optimal fulfillment/delivery option that will meet the SLA between the online retailer and the user using the third set of rules can comprise grouping products by a SLA selected by the user. For example, a user can select to order two products for delivery within two business days, and a third product for delivery within five business days.

In some embodiments, the activity of determining the optimal fulfillment/delivery option that will meet the SLA between the online retailer and the user using the third set of rules can comprise an activity of, for each of SLA grouping of the products, selecting only the distributor-carrier options that can fulfill the products with the SLA requirements. In some embodiments, the activity of determining the optimal fulfillment/delivery option that will meet the SLA between the online retailer and the user using the third set of rules can comprise an activity of applying the consolidation algorithm of the second set of rules to each SLA grouping.

As shown in FIG. 4, method 400 can comprise an activity 405 of receiving an indication of user interest in a product from a user accessing a website of an online retailer on an electronic device of the user. In some embodiments, receiving the indication of the user interest in the product comprises receiving a search query related to the product from the user accessing the website of the online retailer on the electronic device of the user. In other embodiments, receiving the indication of the user interest in the product comprises receiving a notification that the user has selected the product on the website of the online retailer on the electronic device of the user and/or has placed the product in the electronic shopping cart of the user at the website of the online retailer on the electronic device of the user.

Method 400 optionally can further comprise an activity of receiving a preferred shipping time for the product from the user. The preferred shipping time can default to a shipping time associated with a SLA between the user and the online retailer. In other embodiments, a user can manually select a preferred shipping time.

Method 400 can further comprise an activity 410 of determining a product shipping cost for the product using the one or more processing modules and a first set of rules. In some embodiments, method 400 can comprise a cost-based SLA sourcing using the first set of rules. In some embodiments, the product shipping cost can comprise a fastest shipping time of the one or more carrier shipping costs of the plurality of shipping costs that are less than the maximum shipping cost (described below) for the product. In other embodiments, the product shipping cost can comprise a least expensive shipping cost of the one or more carrier shipping costs of the plurality of shipping costs that are less than the maximum shipping cost for the product.

The first set of rules can use an algorithm that determines a level of the SLA based upon additional supply chain costs that the online retailer is willing to incur. For example, if the online retailer is willing to spend an extra dollar for each product or order, the algorithm of the first set of rules can determine, for each order, if the online retailer can speed up the delivery by one or more days. If the online retailer can speed up the delivery by one or more days by the online retailer spending an extra predetermined amount, the first set of rules can apply the extra predetermined amount to speed up delivery. If the online retailer cannot speed up the delivery by one or more days by the online retailer spending the extra predetermined amount, the first set of rules can ignore the extra predetermined amount, and also can keep or relax the SLA to slow the delivery option. As an example, the online retailer can be willing to spend the extra predetermined amount if the user is a preferred user, is a minimum threshold level or category of user, or has purchased more than a predetermined minimum amount from the online retailer during a predetermined period of time. As another example, the online retailer can be willing to spend the extra predetermined amount if the profit margin is high enough to cover the extra predetermined amount. In yet a further example, the online retailer can be willing to spend the extra predetermined amount under all circumstances.

Activity 410 can comprise an activity 418 of determining a shipping time requirement of a SLA with the user. Activity 410 can comprise an activity 420 of determining a plurality of carriers comprising a transit time for shipping the product from one of a plurality of fulfillment centers to the user, the transit time being less than or equal to the shipping time requirement of the SLA with the user. In some embodiments, the plurality of carriers is determined irrespective of a daily shipping cutoff time. The daily shipping cutoff time can comprise a time of day where the SLA changes from one day to a next day. For example, many online retailers advertise “order by 2 P.M. [on Monday] to receive by Tuesday.” Thus, in some embodiments, users can have SLA delivery as long as possible during the day, and irrespective of conventional daily cutoff times.

Activity 410 can further comprise an activity 425 of determining a plurality of carrier shipping costs for the product. Each carrier shipping cost of the plurality of carrier shipping cost can be associated with a different carrier of the plurality of carriers. Activity 410 can further comprise an activity 430 of determining a baseline cost for shipping the product. The baseline cost can comprise a lowest carrier shipping cost of the plurality of carrier shipping costs. In other embodiments, this lowest carrier shipping cost can be referred to as a nominal cost.

Activity 410 can further comprise an activity 435 of retrieving a fixed threshold cost for the product. The fixed threshold cost can be based on (1) a forecast of how many products associated with the product will be sold by the online retailer during a predetermined period of time and (2) how much money the online retailer is willing to pay for shipping the product to the user without being reimbursed by the user. In some embodiments, the threshold cost can be considered an amount of money the online retailer is willing to use to subsidize shipping of the product. For example, the threshold cost can consider the extra predetermined amount the online retailer is willing to spend to speed up the delivery of the product by one or more days. The threshold cost can be determined by a financial group associated with the online retailer, and can change periodically. In some embodiments, the threshold cost is product dependent. That is, each product can comprise a threshold cost determined for that specific product. For example, a product such as a refrigerator can have a much different (and likely larger) threshold cost than a threshold cost for a product such as a box of cereal because the price of a refrigerator is much higher than the price for a box of cereal. In some embodiments, the threshold cost for the product can be dependent on the customer or user, as explained above for the extra predetermined amount that the online retailer is willing to pay to speed up delivery.

In some embodiments, activity 410 can further comprise an activity of eliminating from consideration for shipping the product any carrier of the plurality of carriers comprising an unacceptable transit time for shipping the product from one of the plurality of fulfillment centers to the user, the unacceptable transmit time being greater than the shipping time requirement of the SLA with the user. For example, if a particular carrier does not meet the transit time requirements of the SLA, system 300 (FIG. 3) can remove that particular carrier from consideration for shipping of the product to the user.

In some embodiments, activity 410 can further comprise an activity of eliminating from consideration for shipping the product any carrier of the plurality of carriers (1) determined to comprise the transit time for shipping the product that is less than or equal to the shipping time requirement of the SLA with user and also (2) determined to comprise an unacceptable carrier shipping cost that is greater than the maximum shipping cost for the product. For example, if a particular carrier can meet the transit time requirements of the SLA, but the cost is greater than the maximum shipping cost previously calculated, system 300 (FIG. 3) can remove that particular carrier from consideration for shipping of the product to the user.

In some embodiments, a user can designate a preferred shipping time for the product. The preferred shipping time can comprise a default shipping time associated with the SLA, or can comprise a preferred shipping time manually entered by the user. In some embodiments, each product can comprise a different threshold cost for each shipping time. For example, a product can comprise a first threshold cost for overnight shipping, a second threshold cost for two-day shipping, a third threshold cost for three- to five-day shipping, and so on. Thus, activity 435 also can comprise retrieving the fixed threshold cost that is associated with the preferred shipping time for the product, as received from the user.

Activity 410 can further comprise an activity 440 of combining the fixed threshold cost and the baseline cost to determine a maximum shipping cost for the product. The maximum shipping cost can be used to determine which of the plurality of shipping costs can be considered for shipping. Thus, activity 410 can further comprise an activity 445 of determining one or more carrier shipping costs of the plurality of carrier shipping costs that are less than the maximum shipping cost for the product. In some embodiments, activity 410 also can further comprise an activity of determining an expected delivery date for the product for every carrier of the plurality of carriers not eliminated from consideration for shipping the product. Thus, the expected delivery date for the product for every carrier of the plurality of carriers not eliminated from consideration for shipping the product can comprise carriers that can deliver the product for less than the maximum shipping cost and also in a shipping time that meets the requirements of the SLA.

Returning to FIG. 4A, method 400 can further comprise an activity 415 of coordinating a display on the electronic device of the user of the product shipping cost of the one or more carrier shipping costs that are less than the maximum shipping cost for the product as determined using the first set of rules and the one or more processing modules. In some embodiments, activity 415 can comprise coordinating the display on a product page for the product on the website of the online retailer on the electronic device of the user of the one or more carrier shipping costs that are less than the maximum shipping cost for the product. The one or more carrier shipping costs that are less than the maximum shipping cost can be displayed before the product has been added to a shopping cart of the user on the website of the online retailer or before online checkout for the product by the user on the website of the online retailer.

FIG. 5 illustrates a block diagram of a portion of system 300 comprising communications system 310, web server 320, display system 360, and/or shipping optimization system 370, according to the embodiment shown in FIG. 3. Each of communications system 310, web server 320, display system 360, and/or shipping optimization system 370, is merely exemplary and not limited to the embodiments presented herein. Each of communications system 310, web server 320, display system 360, and/or shipping optimization system 370, can be employed in many different embodiments or examples not specifically depicted or described herein. In some embodiments, certain elements or modules of communications system 310, web server 320, display system 360, and/or shipping optimization system 370, can perform various procedures, processes, and/or acts. In other embodiments, the procedures, processes, and/or acts can be performed by other suitable elements or modules.

In many embodiments, parameter optimization system 310 can comprise non-transitory memory storage module 512. Memory storage module 512 can be referred to as communications module 512. In many embodiments, communications module 512 can store computing instructions configured to run on one or more processing modules and perform one or more acts of method 400 (FIGS. 4A & 4B) (e.g., activity 405 of receiving an indication of user interest in a product from a user accessing a website of an online retailer on an electronic device of the user (FIG. 4A)).

In many embodiments, display system 360 can comprise non-transitory memory storage module 562. Memory storage module 562 can be referred to as display module 562. In many embodiments, display module 562 can store computing instructions configured to run on one or more processing modules and perform one or more acts of method 400 (FIGS. 4A & 4B) (e.g., activity 415 of coordinating a display on the electronic device of the user of the product shipping cost of the one or more carrier shipping costs that are less than the maximum shipping cost for the product as determined using the first set of rules and the one or more processing modules (FIG. 4A).

In many embodiments, shipping optimization system 370 can comprise non-transitory memory storage module 572. Memory storage module 572 can be referred to as shipping optimization module 572. In many embodiments, shipping optimization module 572 can store computing instructions configured to run on one or more processing modules and perform one or more acts of method 400 (FIGS. 4A & 4B) (e.g., activity 410 of determining a product shipping cost for the product using the one or more processing modules and a first set of rules (FIG. 4A), including activity 418 of determining a shipping time requirement of a SLA with the user (FIG. 4B), activity 420 of determining a plurality of carriers comprising a transit time for shipping the product that is less than or equal to a shipping time requirement of a SLA with the user (FIG. 4B), activity 425 of determining a plurality of carrier shipping costs for the product, each carrier shipping cost of the plurality of carrier shipping cost being associated with a different carrier of the plurality of carriers (FIG. 4B), activity 430 of determining a baseline cost for shipping the product, the baseline cost comprising a lowest carrier shipping cost of the plurality of carrier shipping costs (FIG. 4B), activity 435 of retrieving a fixed threshold cost for the product (FIG. 4B), activity 440 of combining the fixed threshold cost and the baseline cost to determine a maximum shipping cost for the product (FIG. 4B), activity 445 of determining one or more carrier shipping costs of the plurality of carrier shipping costs that are less than the maximum shipping cost for the product (FIG. 4B), and activity 447 of determining an expected delivery date for the product (FIG. 4B)).

Although determining product shipping costs for products sold from an online retailer has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIGS. 4A-B may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform acts of:
receiving an indication of user interest in a product from a user accessing a website of an online retailer on an electronic device of the user;
determining a product shipping cost for the product using the one or more processing modules and a first set of rules by:
determining a shipping time requirement of a service level agreement (SLA) with the user;
determining a plurality of carriers comprising a transit time for shipping the product from one of a plurality of fulfillment centers to the user, the transit time being less than or equal to the shipping time requirement of the SLA with the user;
determining a plurality of carrier shipping costs for the product, each carrier shipping cost of the plurality of carrier shipping cost being associated with a different carrier of the plurality of carriers;
determining a baseline cost for shipping the product, the baseline cost comprising a lowest carrier shipping cost of the plurality of carrier shipping costs;
retrieving a fixed threshold cost for the product;
combining the fixed threshold cost and the baseline cost to determine a maximum shipping cost for the product; and
determining one or more carrier shipping costs of the plurality of carrier shipping costs that are less than the maximum shipping cost for the product; and
coordinating a display on the electronic device of the user of the product shipping cost of the one or more carrier shipping costs that are less than the maximum shipping cost for the product as determined using the first set of rules and the one or more processing modules.

2. The system of claim 1, wherein:
determining the plurality of carriers comprises determining the plurality of carriers comprising the transit time for shipping the product that is less than or equal to the shipping time requirement of the SLA with the user irrespective of a daily shipping cutoff time;
the one or more non-transitory storage modules storing computing instructions are further configured to run on the one or more processing modules and perform acts of:
eliminating from consideration for shipping the product any carrier of the plurality of carriers comprising an unacceptable transit time for shipping the product from one of the plurality of fulfillment centers to the user, the unacceptable transmit time being greater than the shipping time requirement of the SLA with the user;
eliminating from consideration for shipping the product any carrier of the plurality of carriers (1) determined to comprise the transit time for shipping the product that is less than or equal to the shipping time requirement of the SLA with user and also (2) determined to comprise an unacceptable carrier shipping cost that is greater than the maximum shipping cost for the product; and
determining an expected delivery date for the product for every carrier of the plurality of carriers not eliminated from consideration for shipping the product; and
coordinating the display on the electronic device of the user of the product shipping cost comprises coordinating the display on a product page for the product on the website of the online retailer on the electronic device of the user of the one or more carrier shipping costs that are less than the maximum shipping cost for the product before the product has been added to a shopping cart of the user on the website of the online retailer or before online checkout for the product by the user on the website of the online retailer.

3. The system of claim 1, wherein the product shipping cost comprises a fastest shipping time of the one or more carrier shipping costs of the plurality of shipping costs that are less than the maximum shipping cost for the product.

4. The system of claim 1, wherein the product shipping cost comprises a least expensive shipping cost of the one or more carrier shipping costs of the plurality of shipping costs that are less than the maximum shipping cost for the product.

5. The system of claim 1, wherein receiving the indication of the user interest in the product comprises receiving a search query related to the product from the user accessing the website of the online retailer on the electronic device of the user.

6. The system of claim 1, wherein receiving the indication of the user interest in the product comprises receiving a notification that the user has selected the product on the website of the online retailer on the electronic device of the user.

7. The system of claim 1, wherein the fixed threshold cost is based on (1) a forecast of how many products associated with the product will be sold by the online retailer during a predetermined period of time and (2) how much money the online retailer is willing to pay for shipping the product to the user without being reimbursed by the user.

8. The system of claim 1, wherein:
the one or more non-transitory storage modules storing computing instructions are further configured to run on the one or more processing modules and perform an act of receiving a preferred shipping time for the product from the user; and
retrieving the fixed threshold cost for the product comprises retrieving the fixed threshold cost that is associated with the preferred shipping time for the product as received from the user.

9. The system of claim 1, wherein the one or more non-transitory storage modules storing computing instructions are further configured to run on the one or more processing modules and perform an act of selecting an optimal delivery option using the one or more processing modules and a second set of rules by:
generating a plurality of combinations of distributors that can fulfill an order for the product, the distributors comprising a warehouse for the online retailer, a third party fulfillment center, or a physical brick and mortar store for the online retailer;
assigning a product quantity to each combination of the plurality of combinations of distributors to create different assignments for the plurality of combinations of distributors;
assigning a carrier of the plurality of carriers to one of the different assignments for the plurality of combinations of distributors;
creating a solution that can fulfill the order; and
selecting a least expensive solution for the order.

10. The system of claim 1, wherein:
determining the plurality of carriers comprises determining the plurality of carriers comprising the transit time for shipping the product that is less than or equal to the shipping time requirement of the SLA with the user irrespective of a daily shipping cutoff time;
the one or more non-transitory storage modules storing computing instructions are further configured to run on the one or more processing modules and perform acts of:
eliminating from consideration for shipping the product any carrier of the plurality of carriers comprising an unacceptable transit time for shipping the product from one of the plurality of fulfillment centers to the user, the unacceptable transmit time being greater than the shipping time requirement of the SLA with the user;
eliminating from consideration for shipping the product any carrier of the plurality of carriers (1) determined to comprise the transit time for shipping the product that is less than or equal to the shipping time requirement of the SLA with user and also (2) determined to comprise an unacceptable carrier shipping cost that is greater than the maximum shipping cost for the product; and
determining an expected delivery date for the product for every carrier of the plurality of carriers not eliminated from consideration for shipping the product;
coordinating the display on the electronic device of the user of the product shipping cost comprises coordinating the display on a product page for the product on the website of the online retailer on the electronic device of the user of the one or more carrier shipping costs that are less than the maximum shipping cost for the product before the product has been added to a shopping cart of the user on the website of the online retailer or before online checkout for the product by the user on the website of the online retailer;
the product shipping cost comprises at least one of (1) a fastest shipping time of the one or more carrier shipping costs of the plurality of shipping costs that are less than the maximum shipping cost for the product, or (2) a least expensive shipping cost of the one or more carrier shipping costs of the plurality of shipping costs that are less than the maximum shipping cost for the product;
receiving the indication of the user interest in the product comprises receiving at least one of (1) a search query related to the product from the user accessing the website of the online retailer on the electronic device of the user, or (2) a notification that the user has selected the product on the website of the online retailer on the electronic device of the user;
the fixed threshold cost is based on (1) a forecast of how many products associated with the product will be sold by the online retailer during a predetermined period of time and (2) how much money the online retailer is willing to pay for shipping the product to the user without being reimbursed by the user;
the one or more non-transitory storage modules storing computing instructions are further configured to run on the one or more processing modules and perform an act of receiving a preferred shipping time for the product from the user;
retrieving the fixed threshold cost for the product comprises retrieving the fixed threshold cost that is associated with the preferred shipping time for the product as received from the user; and
the one or more non-transitory storage modules storing computing instructions are further configured to run on the one or more processing modules and perform an act of selecting an optimal delivery option using the one or more processing modules and a second set of rules by:
generating a plurality of combinations of distributors that can fulfill an order for the product, the distributors comprising a warehouse for the online retailer, a third party fulfillment center, or a physical brick and mortar store for the online retailer;
assigning a product quantity to each combination of the plurality of combinations of distributors to create different assignments for the plurality of combinations of distributors;
assigning a carrier of the plurality of carriers to one of the different assignments for the plurality of combinations of distributors;
creating a solution that can fulfill the order; and
selecting a least expensive solution for the order.

11. A method comprising:
receiving an indication of user interest in a product from a user accessing a website of an online retailer on an electronic device of the user;
determining a product shipping cost for the product using one or more processing modules and a first set of rules by:
determining a shipping time requirement of a service level agreement (SLA) with the user;
determining a plurality of carriers comprising a transit time for shipping the product that is less than or equal to the SLA of the service level agreement with the user;
determining a plurality of carrier shipping costs for the product, each carrier shipping cost of the plurality of carrier shipping cost being associated with a different carrier of the plurality of carriers;
determining a baseline cost for shipping the product, the baseline cost comprising a lowest carrier shipping cost of the plurality of carrier shipping costs;
retrieving a fixed threshold cost for the product;
combining the fixed threshold cost and the baseline cost to determine a maximum shipping cost for the product; and
determining one or more carrier shipping costs of the plurality of carrier shipping costs that are less than the maximum shipping cost for the product; and
coordinating a display on the electronic device of the user of the product shipping cost of the one or more carrier shipping costs that are less than the maximum shipping cost for the product as determined using the first set of rules and the one or more processing modules.

12. The method of claim 11, wherein:
determining the plurality of carriers comprises determining the plurality of carriers comprising the transit time for shipping the product that is less than or equal to the shipping time requirement of the SLA with the user irrespective of a daily shipping cutoff time;
the method further comprises:
eliminating from consideration for shipping the product any carrier of the plurality of carriers comprising an unacceptable transit time for shipping the product from one of the plurality of fulfillment centers to the user, the unacceptable transmit time being greater than the shipping time requirement of the SLA with the user;
eliminating from consideration for shipping the product any carrier of the plurality of carriers (1) determined to comprise the transit time for shipping the product that is less than or equal to the shipping time requirement of the SLA with user and also (2) determined to comprise an unacceptable carrier shipping cost that is greater than the maximum shipping cost for the product; and
determining an expected delivery date for the product for every carrier of the plurality of carriers not eliminated from consideration for shipping the product; and
coordinating the display on the electronic device of the user of the product shipping cost comprises coordinating the display on a product page for the product on the website of the online retailer on the electronic device of the user of the one or more carrier shipping costs that are less than the maximum shipping cost for the product before the product has been added to a shopping cart of the user on the website of the online retailer or before online checkout for the product by the user on the website of the online retailer.

13. The method of claim 11, wherein the product shipping cost comprises a fastest shipping time of the one or more carrier shipping costs of the plurality of shipping costs that are less than the maximum shipping cost for the product.

14. The method of claim 11, wherein the product shipping cost comprises a least expensive shipping cost of the one or more carrier shipping costs of the plurality of shipping costs that are less than the maximum shipping cost for the product.

15. The method of claim 11, wherein receiving the indication of the user interest in the product comprises receiving a search query related to the product from the user accessing the website of the online retailer on the electronic device of the user.

16. The method of claim 11, wherein receiving the indication of the user interest in the product comprises receiving a notification that the user has selected the product on the website of the online retailer on the electronic device of the user.

17. The method of claim 11, wherein the fixed threshold cost is based on (1) a forecast of how many products associated with the product will be sold by the online retailer during a predetermined period of time and (2) how much money the online retailer is willing to pay for shipping the product to the user without being reimbursed by the user.

18. The method of claim 11, wherein:
the method further comprises receiving a preferred shipping time for the product from the user; and
retrieving the fixed threshold cost for the product comprises retrieving the fixed threshold cost that is associated with the preferred shipping time for the product as received from the user.

19. The method of claim 11, wherein the method further comprises selecting an optimal delivery option using the one or more processing modules and a second set of rules by:
generating a plurality of combinations of distributors that can fulfill an order for the product, the distributors comprising a warehouse for the online retailer, a third party fulfillment center, or a physical brick and mortar store for the online retailer;
assigning a product quantity to each combination of the plurality of combinations of distributors to create different assignments for the plurality of combinations of distributors;
assigning a carrier of the plurality of carriers to one of the different assignments for the plurality of combinations of distributors;
creating a solution that can fulfill the order; and
selecting a least expensive solution for the order.

20. The method of claim 11, wherein:
determining the plurality of carriers comprises determining the plurality of carriers comprising the transit time for shipping the product that is less than or equal to the shipping time requirement of the SLA with the user irrespective of a daily shipping cutoff time;
the method further comprises:
eliminating from consideration for shipping the product any carrier of the plurality of carriers comprising an unacceptable transit time for shipping the product from one of the plurality of fulfillment centers to the user, the unacceptable transmit time being greater than the shipping time requirement of the SLA with the user;
eliminating from consideration for shipping the product any carrier of the plurality of carriers (1) determined to comprise the transit time for shipping the product that is less than or equal to the shipping time requirement of the SLA with user and also (2) determined to comprise an unacceptable carrier shipping cost that is greater than the maximum shipping cost for the product; and
determining an expected delivery date for the product for every carrier of the plurality of carriers not eliminated from consideration for shipping the product; and
coordinating the display on the electronic device of the user of the product shipping cost comprises coordinating the display on a product page for the product on the website of the online retailer on the electronic device of the user of the one or more carrier shipping costs that are less than the maximum shipping cost for the product before the product has been added to a shopping cart of the user on the website of the online retailer or before online checkout for the product by the user on the website of the online retailer;
the product shipping cost comprises at least one of (1) a fastest shipping time of the one or more carrier shipping costs of the plurality of shipping costs that are less than the maximum shipping cost for the product, or (2) a least expensive shipping cost of the one or more carrier shipping costs of the plurality of shipping costs that are less than the maximum shipping cost for the product;
receiving the indication of the user interest in the product comprises receiving at least one of (1) a search query related to the product from the user accessing the website of the online retailer on the electronic device of the user, or (2) a notification that the user has selected the product on the website of the online retailer on the electronic device of the user;
the fixed threshold cost is based on (1) a forecast of how many products associated with the product will be sold by the online retailer during a predetermined period of time and (2) how much money the online retailer is willing to pay for shipping the product to the user without being reimbursed by the user;
the one or more non-transitory storage modules storing computing instructions are further configured to run on the one or more processing modules and perform an act of receiving a preferred shipping time for the product from the user;
retrieving the fixed threshold cost for the product comprises retrieving the fixed threshold cost that is associated with the preferred shipping time for the product as received from the user; and
the method further comprises selecting an optimal delivery option using the one or more processing modules and a second set of rules by:
generating a plurality of combinations of distributors that can fulfill an order for the product, the distributors comprising a warehouse for the online retailer, a third party fulfillment center, or a physical brick and mortar store for the online retailer;
assigning a product quantity to each combination of the plurality of combinations of distributors to create different assignments for the plurality of combinations of distributors;
assigning a carrier of the plurality of carriers to one of the different assignments for the plurality of combinations of distributors;
creating a solution that can fulfill the order; and
selecting a least expensive solution for the order.
